(19) United States
(12) Patent Application Publication
(10) Pub. No.: US 2007/0023364 A1
(43) Pub. Date: Feb. 1, 2007

(54) Tetrasilver Tetraoxide as Disinfective Agent for Cryptosporidium

(76) Inventors: I. Cecil Felkner, Bluffton, SC (US); Albert T. Pastore, Warrington, PA (US)

Correspondence Address: ROBERT C. KAIN, JR., 750 SOUTHEAST THIRD AVENUE, SUITE 100, FT LAUDERDALE, FL, 333161153, US

(21) Appl. No.: 11/459,675

(22) Filed: Jul. 25, 2006

Related U.S. Application Data
(60) Provisional application No. 60/703,354, filed on Jul. 28, 2005.

(51) Int. Cl. C02F 1/68

(52) U.S. Cl. 210/764

(57) ABSTRACT

The invention relates to a method for disinfecting water contaminated with Cryptosporidium parvum oocysts and to other similar pathogenic parasites by adding monopotassium persulfate activated/oxidized tetrasilver tetraoxide (TTO) to water intended to be potable for human consumption. It addresses methods that improve penetration of this disinfectant to improve efficacy. The procedure has been assessed for viable oocysts by scientifically sound methods (i.e., excystation and infectivity) to show that the killing of oocysts is related to the dose of the TTO administered.

This application is based upon and claims the benefit of provisional patent application Ser. No. 60/703,354 filed Jul. 28, 2005, now pending.

The invention relates to a method for disinfecting water contaminated with Cryptosporidium parvum oocysts and to other similar pathogenic parasites by adding monopotassium persulfate activated/oxidized tetrasilver tetraoxide (TTO).

### FIELD OF INVENTION

This invention relates to a method for the disinfection of Cryptosporidium oocysts and the potential disinfection Giardia cysts using aqueous solutions of tetrasilver tetraoxide activated with various oxidizing agents, preferably potassium monopersulfate, but including other oxidizing agents such as hydrogen peroxide. Although other forms of silver, such as monovalent silver ions and ions from tetravalent silver were proven active against bacteria, fungi, algae and viruses, none have previously been effective in inactivating oocysts and cysts of these waterborne pathogens. This is because the unique chemical/physical wall structure of the oocysts serves as a barrier to penetration of most disinfectants, e.g., chlorine, and protects the infectious sporozoites within. The invention overcomes the problem associated with the penetration barrier so that sporozoite excystation, i.e., the release of sporozoites from the oocysts, and infectivity are prevented.

### BACKGROUND

It is generally accepted and understood that water, especially surface waters and even some underground sources, can become contaminated by a variety of undesirable microbes. This includes, but is not limited to bacteria, viruses, algae and protozoans. Thus a wide variety of treatments and treatment chain systems were developed to disinfect and/or maintain potable water at a safe level.

The most common disinfection method for drinking and recreational water is chlorination. However, chlorination causes a number of problems, which includes, but is not limited to its objectionable odor, skin and eye irritation for recreational facilities such as swimming pools, spas, etc. It poses a potential long term health threat to consumers of drinking water because chlorine forms trihalomethanes in the presence of organic materials and these compounds have been listed as carcinogens and mutagens by the U.S. Environmental Protection Agency. Some of the other halogens such as bromine may also cause adverse health effects. Halogens such as iodine, which have been used in the field by campers, military troops, etc., have proved to be very effective against bacterial pathogens.

Test studies confirmed these observations using doses of 5 and 15 ppm of iodine against three waterborne pathogens (Escherichia coli, Enterococcus faecalis and Pseudomonas aeruginosa). The data showed that 5 ppm iodine achieved a 6 log10 reduction within 5 min and as much as 8 log10 inactivation within 10 min. of exposure. Unfortunately, experiments using iodine even up to 100 ppm (saturation level) were ineffective in killing Cryptosporidium oocysts when exposed for 30 and 60 min. periods, respectively.

It should be noted that the use of the Kinyoun acid-fast stain or fluorogenic vital dyes cannot be used to assess the viability of Cryptosporidium oocysts or Giardia cysts because they fail to differentiate between viable and inviable organisms. The use of excystation analysis, infectivity in cell cultures, and live animal studies are reliable tests and are accepted by the U.S. Environmental Protection Agency.

Due to the potential long-term adverse health effects, the objectionable chemical and physical properties of chlorine as well as its ineffectiveness against various pathogens (e.g., oocysts of Cryptosporidium and cysts of Giardia), a number of alternative water treatment systems which operate without chlorine have recently been developed.

One such alternative used to disinfect water is ozone gas. In U.S. Pat. No. 4,176,061 to Stopka, ozone has been used for several years to purify drinking water, stating numerous advantages over chlorine. Stopka 061 cites references that teach the advantages of ozone rather than chlorine to disinfect water. The EPA/NSF ETV Drinking Water Systems Center, December 2001, verified the status of ozone disinfection. However, Stopka 061 does not disclose the disadvantages of using ozone, e.g., as a gas, it dissipates over time as O₂ and O evolve, leaving water again susceptible to pathogens.

The EPA/NSF ETV verified ultraviolet (UV) radiation as a way to inactivate pathogens, including Cryptosporidium parvum (May, 1999). However, UV penetration into water is limited to a short distance, potentially allowing some microbes to either escape untouched by the radiation or to receive a sub-lethal dose. In addition, it is well established that UV is mutagenic for virtually all microbes, which leaves the possibility for microbes receiving sub-lethal radiation doses to mutate into resistant types (e.g., antibiotic resistant), and become a long-term health/environmental threat.

Water disinfection systems that contain oligodymamic metal ions that incapacitate microorganisms are also utilized in water purification. This includes transition metals such as copper or silver as well as combinations of these two. For example, U.S. Pat. No. 4,608,247 to Heinig, Jr. describes a water treatment system that utilizes water flow over a material that erodes and provides particulate silver in a water suspension. The particulate silver is claimed to be ionic, but the patent does not disclose the valency of the ions formed by erosion. The reference of Antelman (1979), suggests that trace monovalent ions formed from silver are released.

In U.S. Pat. No. 5,352,369 to Heinig, Jr. the erosion of elemental silver to release silver ions (presumably monovalent) is initiated when water is exposed to a silver catalyst in the presence of oxygen, forming an active oxidizer. This method is only partially effective in avoiding the use of chlorine as an antimicrobial agent. The silver catalyst comprises an alumina matrix, which has approximately 0.1% to 5% elemental silver, chemically deposited upon the matrix, in which the oxygen source is preferably ozone.

The addition of multivalent silver compounds to water for disinfection is disclosed in U.S. Pat. Nos. 5,017,295; 5,073,382; 5,078,902; 5,089,275; 5,098,582; 5,211,855 and 5,223,149 to Antelman. In U.S. Pat. No. 5,211,855, Antelman discloses and claims a water treatment method comprising the addition of tetrasilver tetraoxide to water bodies, such as reservoirs. Antelman 855 also makes a correction in identifying the antimicrobial component tetrasilver tetraoxide as Ag₄O₄ rather than silver (II) oxide (i.e., AgO), wherein each molecule is comprised of one pair of monovalent silver atoms and one pair of trivalent silver atoms. See also generally, U.S. Pat. No. 5,336,149 to Antelman.

In U.S. Pat. No. 5,211,855 to Antelman, the disclosure claims a water treatment method in which Ag₄O₄ (trivalent silver compound) is bactericidal and algicidal. Antelman 855 asserts that the trivalent silver compounds are an improvement over the divalent silver compounds disclosed in the earlier U.S. patents identified here above. Antelman 855 also teaches that oxidizing agents need not be used with trivalent silver compounds.

U.S. Pat. No. 6,346,201 to Felkner teaches that ozonated tetrasilver tetraoxide, A404 provides a water disinfection method and also provides a method for increasing the half-life of ozone in water while providing a tetrasilver tetraoxide residual. Felkner 201 teaches that this method overcomes the problem of early ozone dissipation in water, which would leave the treated water susceptible to re-infection by pathogens and by bacterial endospores of the Bacillus species, normally resistant to disinfection by conventional treatments such as chlorination.

Despite the foregoing developments, none have improved the art so that oocysts of Cryptosporidium and cysts of Giardia are killed by disinfection action. The oocysts of Cryptosporidium, while not as resistant to heat inactivation/sterilization as bacterial endospores, have a unique wall structure that serves as a barrier to the penetration of most chemical disinfectants, e.g., halogens such as chlorine, bromine, and iodine. Thus, chemical disinfectants active against bacterial endospores or other hardy microbes cannot necessarily be expected to inactivate oocysts (whose cell walls which serve as a barrier to sporozoites within, Fayer, 1997).

A system for generating potable drinking water has been developed which utilizes treatment with a disinfectant to eliminate pathogenic microbes followed by removal of the disinfectant by a series of mechanical filtrations and discharge of disinfectant-free and pathogen-free water. Originally it was thought that treatment with a halogen such as iodine could be used to eliminate all pathogens, including bacteria, viruses and protozoans, namely Cryptosporidium and Giardia species. The latter occur in water sources in the form of oocysts and cysts, which are known to be highly resistant to halogens such as chlorine, iodine and bromine.

It was concluded from test studies that iodine can be used successfully for killing some selected bacterial pathogenic strains, i.e., Escherichia coli, Enterococcus faecalis, and Pseudomonas aeruginosa, but is ineffective for killing Cryptosporidium oocysts. Therefore, an effective disinfectant for killing these oocysts was sought. Tetrasilver tetraoxide was considered to be a viable candidate based on the fact that silver compounds have, for many centuries, been used to purify water for drinking and for the prevention/treatment pathogenic microbes.

### SUMMARY OF THE INVENTION

The invention provides a water disinfection method for Cryptosporidium parvum and similar pathogens using tetrasilver tetraoxide activated/oxidized by potassium monopersulfate with or without the aid of a cocktail solution comprised of COREXIT (EC9527A; a dispersant made by Nalco Energy Services, L.P. of Sugarland, Tex. or ExxonMobile) and ALKAMUS EL 620 (Rhone-Poulenc, Cranbury, N.J.). This cocktail was developed to facilitate uptake of toxicants and/or disinfectants through microbial cell wall barriers. Experimental data establish the efficacy of this disinfection agent and methods for inactivation Cryptosporidium oocysts.

### OBJECTS OF THE INVENTION

It is an object of the present invention to provide a new method of disinfecting water.

It is another object of the present invention to provide a method for disinfecting water contaminated with Cryptosporidium parvum oocysts and to other similar pathogenic parasites.

It is an additional object of the present invention to provide a method for disinfecting water by adding monopotassium persulfate activated/oxidized tetrasilver tetraoxide (TTO).

It is a further object of the present invention to provide a method for disinfecting water contaminated with Cryptosporidium parvum oocysts and to other similar pathogenic parasites by adding monopotassium persulfate activated/oxidized tetrasilver tetraoxide (TTO).

It is an object of the present invention to provide a new method to improve penetration of the TTO disinfectant and thereby to improve efficacy.

Further objects and advantages of the present invention can be found in the detailed description of the preferred embodiments.

### DETAILED DESCRIPTION OF PREFERRED EMBODIMENTS

It was discovered that tetrasilver tetraoxide, in its oxygenated/activated form, has the capacity to inactivate Cryptosporidium oocysts, provided that it can penetrate the unique oocysts wall and reach the infectious sporozoites within. Many previous reports and patents relevant to tetrasilver tetraoxide (TTO) (see Background) disclosed that this TTO compound, when activated, is highly effective against waterborne pathogenic bacteria including E. coli where concentrations as low as 1-2 ppm kill these organisms within 10 min or less. But as with halogenated disinfectants such as chlorine, iodine, and bromine, evidence of bactericidal, algicidal and viricidal activities does not ensure efficacy against cysts and oocysts of Giardia and Cryptosporidium. The advancement of this invention is one that enables inactivation of the latter organisms. The inventors discovered the mechanism of inactivation by interpreting the results of experiments where oocysts were stained with fluorogenic vital dyes in parallel with the same samples assayed for survival based on excystation. In these experiments, staining did not differentiate between live and dead oocysts whereas excystation analysis clearly proved that treatment with activated tetrasilver tetraoxide killed the sporozoites within the oocysts. These results suggested that penetration of TTO past the oocysts wall would lead to successful killing of the sporozoites within.

Only two disinfectants have been verified by the U.S. EPA/NSF/ETV Drinking water System Center as effective against Cryptosporidium oocysts and Giardia cysts. These are ozone and ultraviolet light inactivation. They are effective because they are able to penetrate the oocysts/cyst wall. Ozone treatment of Cryptosporidium oocysts creates “holes” in these bodies (observed by electron microscopy), which in turn allows the ozone to penetrate and reach the sporozoites within, and destroys them. Ultraviolet light passes through the oocysts wall to the sporozoites where it reaches the deoxyribonucleic acid (DNA) chromosomes and forms thymine dimers. This modification of the genetic code inactivates the sporozoites' ability to metabolize normally, form cellular structures, infect or reproduce.

Disadvantages of these prior art methods for inactivation include the dissipation of ozone over time and the limited penetration of UV in water. Also there is the likely creation of mutant microbes by UV interacting with their DNA. Activated tetrasilver tetraoxide avoids these potential drawbacks because it provides a solution for keeping the water pathogen free and it is not mutagenic. In addition, it is to be noted that generation of ozone requires a significant energy input, typically electrical energy, that is costly. Ultraviolet irradiation is very effective in killing oocysts when sufficient UV levels reach the intended target, but from experience of one inventor (Felkner, 1960 Thesis), UV irradiation may not penetrate sufficiently into a water matrix and is likely to cause some disinfection failures, especially if a very thin layer of water is not maintained.

Tetrasilver tetraoxide, a product registered by N. Jonas, Inc. as SILDATE (EPA Registration No. 3432-64 and CAS No. 1301-96-8), has been tested successfully against numerous bacterial and algal strains. It was approved and registered for N. Jonas by USEPA as a disinfectant for use in swimming pools. In order for tetrasilver tetraoxide to be effective, it must activated by oxidizing agents such as potassium monopersulfate (see patent disclosures by Antelman) and hydrogen peroxide. The scientific findings of USEPA included a statement that adequate product chemistry, efficacy (killing of EPA specified microbial species), environmental fate, toxicology and ecological effects data have been reviewed showing that human exposure from the purposed use (treatment of swimming pool water as a disinfectant) is minimal and that the product is practically non-toxic to avian species. However, it is toxic to aquatic species.

However, the Antelman patent disclosures do not disclose nor suggest that TTO is a disinfectant with respect to Cryptosporidium oocysts.

After development of a water purifier system designed to contain the disinfectant within the system and only release disinfectant-free potable drinking water, tetrasilver tetraoxide became an excellent candidate for disinfection of Cryptosporidium parvum oocysts. Although tetrasilver tetraoxide is the most preferred oligodynamic compound for use in the inventive system, it is contemplated that other oligodynamic compounds such as multivalent copper (see, e.g. U.S. Pat. No. 5,336,416 to Antelman) might be substituted provided that they can be made to penetrate the oocysts/cyst cell wall. Alternate oligodynamic metal(s) can be substituted for TTO, e.g., copper or copper/silver combination.

The inventive methods represent an advance in the cleansing of contaminated water, beyond those previously reported when tetrasilver tetraoxide was registered as a disinfectant for use in swimming pools, because the present methods demonstrate the penetration aspects of the TTO, based upon further tests and studies. This advancement improves the quality of the disinfecting product so that protozoan cysts and oocysts, in addition to pathogenic bacteria, viruses and algae, can be disinfected with a contolled amount of residual silver remaining to prevent re-contamination by microbes.

Further details of the inventive methods are illustrated by the following data, but it should be understood that the present invention is not limited to these examples.

Test studies show that when activated tetrasilver tetraoxide-treated (2 ppm tetrasilver tetraoxide and 10 ppm potassium monopersulfate) Cryptosporidium parvum oocysts are stained with fluorogenic vital dyes, there is no difference in the appearance of treated and untreated oocysts. Therefore, this method was shown as not being useful for determining oocysts inactivation. However, when analyzed by excystation, which measures the ability of sporozoites to emerge from the oocysts, only 1.2+/−1.1% proved to be viable. This amounts to approximately 98.8 to 99.0% kill (2 log10 reduction in infectious Cryptosporidium parvum). These results support the perception that tetrasilver tetraoxide does not damage the oocysts directly but must pass through the oocysts wall where it is able to inactivate the infective sporozoites.

Continuing tests on tetrasilver tetraoxide were performed. The following reports summarize the findings:

Initial disinfection studies on Cryptosporidium oocysts showed that a saturated iodine solution with a 1% cocktail of COREXIT and ALKAMUS EL 620 was ineffective for inactivating oocysts for an exposure time of 3 hours, whereas tetrasilver tetraoxide under the same conditions gave 19.4% inactivation of 1×10³ oocysts in 50 ml of Hank's Minimal Essential Medium (HMEM). Excystation, i.e., the release of sporozoites from the oocysts, was used to assess viability of the Cryptosporidium samples. COREXIT is 2-butoxyethanol (ethyleneglycol monobutyl ether), butyl cellosolve, butyl glycol, glycol ether eb. Other ethers similar to ethyleneglycol monobutyl ether may be used. This dispersant is composed of about 48% nonionic surfactants, including ethoxylated sorbitan mono- and trioleates (Tween 80 and Tween 85) and sorbitan monooleate (Span 80), about 35% anionic surfactants, including sodium dioctyl sulfosuccinate (AOT), and about 17% ethylene glycol monobutyl ether as a solvent EMULPHOR is an emulsifier derivative of corn oil. EMULPHOR may also be used rather than ALKAMUS. ALKAMUS is a polyethoxylated castor oil 40 mole ethoxlate. EMULPHOR from BASF, is a high molecular weight ether sulphate.

Further disinfection studies assayed 3 concentrations of tetrasilver tetraoxide activated with potassium persulfate with and without 1% cocktail. Concentrations of tetrasilver tetraoxide at 2, 5, and 10 mg/L were used to treat Cryptosporidium oocysts for 60 min. Disinfection was assessed using cell culture infectivity as the test, this procedure being more definitive than excystation. The test using activated 2 mg/L tetrasilver tetraoxide in 1.0% cocktail gave a 90% oocyst inactivation relative to the stock oocyst control. The 90% inactivation is a Log10 reduction of 1.0. This was an improvement over the first study, suggesting a possible solution to the problem of conveying tetrasilver tetraoxide past the oocysts cell barrier. Other test matrices achieved less than a one Log10 reduction/inactivation.

Embodiments of the invention are useful to kill various microbial pathogens not susceptible to inactivation by conventionally used disinfectants, but more especially Cryptosporidium oocysts or Giardia cysts with live/infectious sporozoites within.

Additional disinfection studies included optimum concentration/exposure for activation of tetrasilver tetraoxide with potassium persulfate and 1 hr. mixing with 1 or 2% cocktail mixtures before exposure of 1.2×10⁷ oocysts/50 mL. The exposures were all for 60 min at 1, 2, and 3 mg/L of tetrasilver tetraoxide, respectively. Using 1 mg/L tetrasilver tetraoxide with 0% cocktail gave 75% inactivation or 0.6 Log10 reductions. However, inactivation percentages ranging from 95 to 98% were achieved with 2 and 3 mg/L tetrasilver tetraoxide either with or without 1% cocktail. There was a 1.3 Log10 reduction with 3 mg/L tetrasilver tetraoxide and 0% cocktail, but a 98% inactivation with 3 mg/L tetrasilver tetraoxide with 1% cocktail [1.8 Log10 oocyst reduction]. A 1.8 Log10 reduction was achieved with 2 mg/L tetrasilver tetraoxide with 0% cocktail. Lesser, but significant inactivations were achieved by raising the cocktail concentrations to 2%. The data indicate that there is an optimum level of cocktail and of potassium monopersulfate or other activator/oxidizer associated with a given tetrasilver tetraoxide concentration. The range of TTO to monopotassium sulfate can be 1:2 to 1:10 and the preferred ratio is 1:5. Alternate oxidizers such as H₂O₂ or HOCL from various sources, e.g., calcium hypochlorite, lithium hypochlorite, sodium hypochlorite, as well as their stabilized forms may be used to activate tetrasilver tetraoxide. In addition, oxidizers such as persulfates, peroxides and oxygen may be used.

Additional data was analyzed to determine whether a dose-related inactivation/killing effect was produced by increasing concentrations of tetrasilver tetraoxide. Infectivity in cell cultures was used in this study. Although excystation is an acceptable way to assay for live sporozoites, infectivity in cell cultures is a definitive assay generally accepted by the scientific community for assessing Cryptosporidium oocyst viability/non-viability. This assay is virtually equivalent to using living mammals to confirm infectious organisms, but it provides better quantitation of viable/infectious organisms. The data clearly show that tetrasilver tetraoxide is effective in killing Cryptosporidium parvum oocysts. Killing occurs in a dose-dependent fashion, which the following averages demonstrate.

Efficacy of Tetrasilve Tetraoxide on Cryptosporidium Parvum in Cell Culture

Average Percent Oocyst Inactivation of all Variables

| | |
|---|---|
| 0 mg/L TTO | 0.0% |
| 1 mg/L TTO | 32.0% |
| 2 mg/L TTO | 65.0% |
| 3 mg/L TTO | 87.0% |

Average Log10 Reduction of Viable Oocysts (Inactivation)

| | |
|---|---|
| 0 mg/L TTO | 0.0 |
| 1 mg/L TTO | 0.23 |
| 2 mg/L TTO | 0.83 |
| 3 mg/L TTO | 1.2 |

Average Infectious Oocysts × 100,000

| | |
|---|---|
| 0 mg/L TTO | 100 |
| 1 mg/L TTO | 68 |
| 2 mg/L TTO | 35 |
| 3 mg/L TTO | 13 |

Infectious Oocysts × 100,000 using 1% Cocktail

| | |
|---|---|
| 1 mg/L TTO, 5 mg/L persulfate | 100 |
| 2 mg/L TTO, 10 mg/L persulfate | 35 |
| 3 mg/L TTO, 15 mg/L persulfate | 2 |

*[1.8 Log10 reduction or 98% kill of oocysts at 3 mg/L]

Infectious Oocytes × 100,000 using 0% Cocktail

| | |
|---|---|
| 0 mg/L TTO, 5 mg/L persulfate | 100 |
| 2 mg/L TTO, 10 mg/L persulfate | 2 |

*[1.8 Log10 reduction or 98% kill of oocysts at 2 mg/L]

From the above analysis, it is concluded that a 1.8 Log10 reduction or 98% kill of oocysts has been achieved with exposure to 2 and 3 mg/L of activated tetrasilver tetraoxide, irrespective of cocktail used. At a concentration of 3 mg/L, the inactivation is 6.5 times more effective when the cocktail is present than for the average inactivation of infectious oocysts. While not necessarily wishing to be bound by theory in its entirety, the results suggest that the activation by persulfate to create ionic silver is the limiting factor, but the addition of 1.0% cocktail facilitates penetration of tetrasilver tetraoxide when concentrations are in excess of 2 mg/L. While not to be bound by theory, the use of a “carrier” type of material may facilitate better penetration of TTO concentrations greater than those shown in the experimental tests presented above. It is also possible that silver (III) or other oligodynamic metals may not require oxidative activation if penetration can be enhanced via cocktail.

Absolute CT values (Concentration×Exposure Time) were not determined from these studies, but they are expected to be comparable to that achieved with ozone treatment when more detailed kinetic experiments have been finished. The use of other oxidizing agents for activation of tetrasilver tetraoxide will be contemplated at some future date, e.g., H₂O₂. The Log10 reduction values from this study are comparable to those achieved with ozone-exposed Cryptosporidium, i.e., a Log 10 reduction of 2.0 (which is accepted by USEPA) and if the 98.8%+/−1.1% value is considered, rounding up to 99% is equal to a 2.0 Log10 reduction. Further improvements can be logically expected using increased concentrations of tetrasilver tetraoxide provided there is enhanced penetration.

If low CT values can be obtained with tetrasilver tetraoxide, the system will be very effective and commercially competitive against existing products for killing Cryptosporidium oocysts and other chlorine-resistant microbes.

While the invention has been described in detail and with reference to specific examples, it will be apparent to one skilled in the art that various changes and modifications can be made therein without departing from the spirit and scope thereof. For example, very low CT values are expected when certain changes and modifications are made relative to penetration and release of active silver ions.

The claims appended hereto are meant to cover modifications and changes within the scope and spirit of the present invention.

What is claimed is:

1. A method for disinfection of Cryptosporidium oocysts in water, the method comprising the addition of tetrasilver tetraoxide activated with monopotassium sulfate to a suspension of Cryptosporidium oocysts.

2. A method for disinfection of Cryptosporidium oocysts as claimed in claim 1 wherein the tetrasilver tetraoxide is activated with monopotassium sulfate, in a ratio range of 1:2 to 1:10.

3. A method for disinfection of Cryptosporidium oocysts as claimed in claim 2 wherein the tetrasilver tetraoxide activated with monopotassium sulfate in a 1:5 ratio.

4. The method of claim 1, wherein a suspension of Cryptosporidium oocysts at 100,000/mL (10⁷/Liter) or less is reduced in dose related fashion with increasing concentrations of tetrasilver tetraoxide.

5. The method of claim 1, wherein a cocktail consisting of Alkamus® and Corexit® is added to enhance penetration of the disinfectant into the oocysts.

6. The method of claim 1, wherein a cocktail consisting of 2-butoxyethanol and polyethoxylated vegetable oil is added to enhance penetration of the disinfectant into the oocysts.

7. The method of claim 1, wherein a cocktail consisting of a polyethoxylated vegetable oil and a dispersant is added to enhance penetration of the disinfectant into the oocysts.

8. The method of claim 3, wherein a suspension of Cryptosporidium oocysts at 100,000/mL (10⁴/Liter) or less is reduced in dose related fashion with increasing concentrations of tetrasilver tetraoxide.

9. The method of claim 8, wherein a cocktail consisting of Alkamus® and Corexit® is added to enhance penetration of the disinfectant into the oocysts.

10. The method of claim 8, wherein a cocktail consisting of 2-butoxyethanol and polyethoxylated vegetable oil is added to enhance penetration of the disinfectant into the oocysts.

11. The method of claim 3, wherein a cocktail consisting of a polyethoxylated vegetable oil and a dispersant is added to enhance penetration of the disinfectant into the oocysts.

12. A method for disinfection of Cryptosporidium oocysts in water, the method comprising the addition of tetrasilver tetraoxide activated with an oxidizer, from the group of oxidizers consisting of monopotassium sulfate persulphates, peroxides and oxygen, to a suspension of Cryptosporidium oocysts.

13. A method for disinfection of Cryptosporidium oocysts as claimed in claim 12 wherein the tetrasilver tetraoxide is activated with said oxidizer, in a ratio range of 1:2 to 1:10.

14. A method for disinfection of Cryptosporidium oocysts as claimed in claim 13 wherein the tetrasilver tetraoxide activated with said oxidizer in a 1:5 ratio.

15. The method of claim 12, wherein a suspension of Cryptosporidium oocysts at 100,000/mL (10⁷/Liter) or less is reduced in dose related fashion with increasing concentrations of tetrasilver tetraoxide.

16. The method of claim 12, wherein a cocktail consisting of a polyethoxylated vegetable oil and a dispersant is added to enhance penetration of the disinfectant into the oocysts.

17. A method for disinfection of Cryptosporidium oocysts in water, the method comprising the addition an oligodynamic metal, selected from the group of oligodynamic metals consisting of tetrasilver tetraoxide, copper or copper/silver combination, said oligodynamic metal activated with an oxidizer, from the group of oxidizers consisting of monopotassium sulfate persulphates, peroxides and oxygen, to a suspension of Cryptosporidium oocysts.

18. The method of claim 17, wherein a cocktail consisting of Alkamus® and Corexit® is added to enhance penetration of the disinfectant into the oocysts.

19. The method of claim 17, wherein a cocktail consisting of 2-butoxyethanol and polyethoxylated vegetable oil is added to enhance penetration of the disinfectant into the oocysts.

20. The method of claim 17, wherein a cocktail consisting of a polyethoxylated vegetable oil and a dispersant is added to enhance penetration of the disinfectant into the oocysts.
